(19) United States
(12) Patent Application Publication
(10) Pub. No.: US 2026/0186270 A1
(43) Pub. Date: Jul. 2, 2026

(54) Camera Optical Lens

(71) Applicant: Changzhou AAC Raytech Optronics Co., Ltd., Changzhou City (CN)

(72) Inventor: Pengfei Li, Changzhou (CN)

(21) Appl. No.: 19/342,562

(22) Filed: Sep. 27, 2025

Related U.S. Application Data
(63) Continuation of application No. PCT/CN2024/144648, filed on Dec. 31, 2024.

(51) Int. Cl. G02B 13/00; G02B 1/04; G02B 9/34; G02B 13/02

(52) U.S. Cl. CPC G02B 13/0065; G02B 9/34; G02B 13/0035; G02B 13/02; G02B 1/04

(57) ABSTRACT

The present invention relates to the field of optical lenses, and discloses a camera optical lens including, in an order from an object side to an image side in sequence: a first lens with positive refractive power, a second lens with negative refractive power, a third lens with negative refractive power, and a triangular prism; wherein image side surface object side surface. The camera optical lens satisfies the following conditions: 0.14≤D/TTL≤0.46; 40.00≤vdi≤82.00; 0.30≤f1/f≤0.70; −32.08≤f23/(d3+d4+d5)≤−3.00; 1.40≤(R5+R6)/(R5−R6)≤20.00.

### CROSS-REFERENCE TO RELATED APPLICATIONS

This application claims the priority benefit of PCT Patent Application Ser. No. PCT/CN2024/144648 filed on Dec. 31, 2024, the entire content of which is incorporated herein by reference.

### FIELD OF THE PRESENT DISCLOSURE

The present invention relates to the field of optical lenses, and particularly relates to a camera optical lens applicable to portable terminal devices such as smartphones and digital cameras, as well as imaging devices such as monitors and PC lenses.

### DESCRIPTION OF RELATED ART

In recent years, with the rise of various smart devices, the demand for miniaturized camera optical lenses has increasingly grown. As the pixel size of photosensitive devices has decreased, coupled with the current trend of electronic products towards high functionality and thin, light, and portable designs, miniaturized camera optical lenses with excellent imaging quality have become the mainstream in the market. Telephoto camera lenses can meet consumers' needs for capturing specific targets. However, traditional telephoto camera lenses have excessively large total optical length (TTL), failing to satisfy the thin-and-light design requirements of smartphones. In contrast, periscope-type telephoto camera lens designs significantly reduce the TTL of camera optical lenses while fulfilling telephoto requirements. Nevertheless, the optical performance of existing periscope-type telephoto camera optical lenses still falls short of demands.

### SUMMARY

To address the above issues, an objective of the present disclosure is to provide a camera optical lens that satisfies the requirements of a large-aperture periscope design while achieving high imaging performance.

To resolve the technical problems, an embodiment of the present disclosure provides a camera optical lens including, in an order from an object side to an image side in sequence: a first lens with positive refractive power, a second lens with negative refractive power, a third lens with negative refractive power, and a triangular prism with negative refractive power; wherein at least one of the first lens, the second lens, and the third lens is a glass lens element, the triangular prism is made of plastic material, and the camera optical lens further satisfies the following conditions:

$$0.14 \leq D / T T L \leq 0.46 ;$$

$$40. \leq vdi \leq 82 \text{.00} ;$$

$$0.3 \leq f 1 / f \leq 0 \text{.70} ;$$

$$- 32. 08 \leq f 23 / ( d 3 + d 4 + d 5 ) \leq - 3 \text{.00} ;$$

$$1.4 \leq ( R 5 + R 6 ) / ( R 5 - R 6 ) \leq 20 \text{.00} ;$$

where
D: the distance on-axis from the object side surface of the first lens to the image side surface of the third lens;
TTL: the total optical length of the camera optical lens;
vdi: the abbe number of the glass lens element in the camera optical lens;
f: the focal length of the camera optical lens;
f1: the focal length of the first lens;
d3: the thickness on-axis of the second lens;
d5: the thickness on-axis of the third lens;
d4: the thickness on-axis from the image side surface of the second lens to the object side surface of the third lens;
f23: the combined focal length of the second lens and the third lens;
R5: the curvature radius of the object side surface of the third lens;
R6: the curvature radius of the image side surface of the third lens.

As an improvement, the camera optical lens further satisfies the following condition:

$$2. 10 \leq I H \times f / F O V \leq 6.10 ;$$

where
IH: the image height at 1.0 field of the camera optical lens;
FOV: the field angle at 1.0 field of the camera optical lens.

As an improvement, the camera optical lens further satisfies the following condition:

$$3. 10 \leq f 1 / d 1 \leq 5.6 ;$$

where
d1: the thickness on-axis of the first lens.

As an improvement, an object side surface of the first lens is convex in the paraxial region, and the camera optical lens further satisfies the following conditions:

$$- 3.03 \leq ( R 1 + R 2 ) / ( R 1 - R 2 ) \leq - 0 \text{.16} ;$$

$$0.065 \leq d 1 / TTL \leq 0 \text{.132} ;$$

where
R1: the curvature radius of the object side surface of the first lens;
R2: the curvature radius of the image side surface of the first lens;
d1: the thickness on-axis of the first lens.

As an improvement, the camera optical lens further satisfies the following conditions:

$$- 13. 36 \leq f 2 / f \leq - 0.55 ;$$

$$- 21. 64 \leq ( R 3 + R 4 ) / ( R 3 - R 4 ) \leq 5 \text{.92} ;$$

$$0.018 \leq d 3 / TTL \leq 0.0 \; 66 ;$$

where
f2: the focal length of the second lens;
R3: the curvature radius of the object side surface of the second lens;
R4: the curvature radius of the image side surface of the second lens.

As an improvement, an object side surface of the third lens is convex in the paraxial region, an image side surface of the third lens is concave in the paraxial region, and the camera optical lens further satisfies the following conditions:

$$- 4.76 \leq f 3 / f \leq - 0.33 ;$$

$$0.013 \leq d 5 / TTL \leq 0.0 \; 82 ;$$

where
f3: the focal length of the third lens.

As an improvement, the camera optical lens further satisfies the following condition:

$$Fno \leq 3.09 ;$$

where
Fno: the F-number of the camera optical lens.

As an improvement, the camera optical lens further satisfies the following condition:

$$TTL / IH \leq 7 \text{.22} ;$$

IH: the image height at 1.0 field of the camera optical lens.

The advantageous effects of the present disclosure are as follows: The camera optical lens according to the present disclosure exhibits excellent optical characteristics, satisfies the design requirements of large-aperture, periscope-type telephoto, and miniaturization, and is particularly suitable for mobile phone camera lens assemblies and web camera lenses composed of high-pixel imaging elements such as CCD and CMOS.

### BRIEF DESCRIPTION OF THE DRAWINGS

To more clearly illustrate the technical solutions in the embodiments of the present disclosure, a brief introduction to the accompanying drawings used in the description of the embodiments will be provided below. Obviously, the drawings in the following description are merely some embodiments of the present disclosure, and for those of ordinary skill in the art, without creative efforts, other drawings may be derived from these drawings.

FIG. 1 is a schematic structural diagram of a camera optical lens in accordance with a first embodiment of the present disclosure;

FIG. 2 shows the longitudinal aberration of the camera optical lens shown in FIG. 1;

FIG. 3 shows the lateral color of the camera optical lens shown in FIG. 1;

FIG. 4 presents a schematic diagram of the field curvature and distortion of the camera optical lens shown in FIG. 1;

FIG. 5 is a schematic structural diagram of a camera optical lens in accordance with a second embodiment of the present disclosure;

FIG. 6 shows the longitudinal aberration of the camera optical lens shown in FIG. 5;

FIG. 7 shows the lateral color of the camera optical lens shown in FIG. 5;

FIG. 8 presents a schematic diagram of the field curvature and distortion of the camera optical lens shown in FIG. 5;

FIG. 9 is a schematic structural diagram of a camera optical lens in accordance with a third embodiment of the present disclosure;

FIG. 10 shows the longitudinal aberration of the camera optical lens shown in FIG. 9;

FIG. 11 shows the lateral color of the camera optical lens shown in FIG. 9;

FIG. 12 presents a schematic diagram of the field curvature and distortion of the camera optical lens shown in FIG. 9;

FIG. 13 is a schematic structural diagram of a camera optical lens in accordance with a fourth embodiment of the present disclosure;

FIG. 14 shows the longitudinal aberration of the camera optical lens shown in FIG. 13;

FIG. 15 shows the lateral color of the camera optical lens shown in FIG. 13;

FIG. 16 presents a schematic diagram of the field curvature and distortion of the camera optical lens shown in FIG. 13.

### DETAILED DESCRIPTION OF THE EXEMPLARY EMBODIMENTS

To make the objectives, technical solutions, and advantages of the embodiments of the present disclosure clearer, the embodiments of the present disclosure will be described in detail below with reference to the accompanying drawings. However, it should be understood by those of ordinary skill in the art that in the embodiments of the present disclosure, many technical details are set forth to enable readers to better understand the present disclosure. Nevertheless, the technical solutions claimed in the present disclosure may be implemented even without these technical details and various variations and modifications based on the following embodiments.

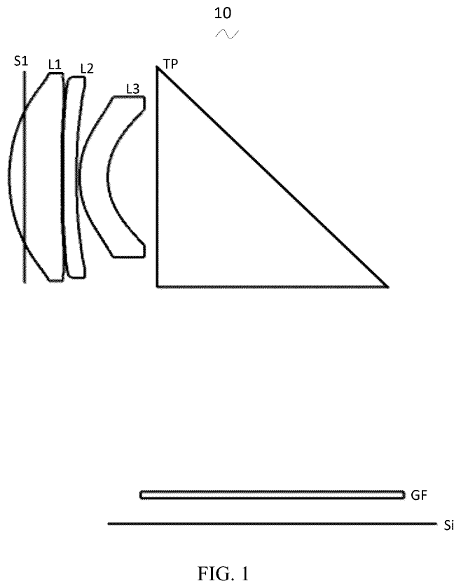

With reference to the accompanying drawings, the present disclosure provides camera optical lenses 10, 20, 30, 40. As shown in FIGS. 1, 5, 9 and 13, each camera optical lens 10, 20, 30, 40 includes a first lens L1 with positive refractive power, a second lens L2 with negative refractive power, a third lens L3 with negative refractive power, and a triangular prism TP, sequentially arranged from the object side to the image side.

The triangular prism TP is made of plastic material, contributing to cost reduction.

An axial distance from the object side surface of the first lens to the image side surface of the third lens in the camera optical lenses 10, 20, 30, 40 is defined as D. The total optical length of the camera optical lenses 10, 20, 30, 40 is defined as TTL. The following relationship is satisfied: 0.14≤D/TTL≤0.46. This relationship constrains the ratio of the lens group length to the system's total optical length. Within this conditional range, it contributes to controlling the front-end length of the periscope-type lens.

At least one of the first lens L1, the second lens L2, and the third lens L3 is a glass lens element.

The Abbe number of the glass lens elements in the camera optical lenses 10, 20, 30, 40 is defined as vdi, the following relationship is satisfied: 40.00≤vdi≤82.00. At least one of the first three lens elements is a glass lens element. This constrains the Abbe number of the employed glass materials. Within this range, material properties can be effectively allocated to correct chromatic aberration, ensuring |LC|≤2.0 μm.

The focal length of the camera optical lenses 10, 20, 30, 40 is defined as f, the focal length of the first lens is defined as f1, and the following relationship is satisfied: 0.30≤f1/f≤0.70. This constrains the ratio of the first lens focal length to the system's total focal length. By rationally allocating the optical power distribution, the system achieves superior imaging quality and reduced sensitivity.

The thickness on-axis of the second lens is defined as d3, the thickness on-axis of the third lens is defined as d5, the distance on-axis from the image side surface of the second lens to the object side surface of the third lens is defined as d4, the combined focal length of the second lens and the third lens is defined as f23, and the following relationship is satisfied: −32.08≤f23/(d3+d4+d5)≤−3.00. When this conditional expression is satisfied, it contributes to maintaining sufficient negative refractive power in the rear lens group to correct off-axis aberrations at the image side, while effectively reducing the total optical length (TTL) to achieve miniaturization, thereby expanding product applicability.

The curvature radius of the object side surface of the third lens as R5, and the curvature radius of the image side surface of the third lens as R6, the following relationship is satisfied: 1.40≤(R5+R6)/(R5−R6)≤20.00. This constrains the shape of the third lens. Within the conditional range, it moderates ray deflection through the lens element and effectively mitigates aberrations.

Under the satisfaction of the above conditional expressions, the camera optical lenses 10, 20, 30, 40 achieve excellent optical performance while meeting the design requirements of large-aperture, telephoto, and miniaturization. According to the characteristics of these lenses, they are particularly suitable for mobile phone camera lens assemblies and web camera lenses composed of high-pixel imaging elements such as CCD and CMOS.

Based on the aforementioned conditional expressions and achievable functions, the features of each lens are further refined as follows.

The image height at 1.0 field of the camera optical lens is defined as IH, and the field of view angle at 1.0 field is defined as FOV, the following relationship is satisfied: 2.10≤IH×f/FOV≤6.10. This ensures imaging quality while facilitating miniaturization and wide-angle design.

The thickness on-axis of the first lens L1 is defined as d1, the following relationship is satisfied: 3.10≤f1/d1≤5.60. When f1/d1 satisfies this relationship, it moderates the incident angle variation of light rays, enabling smooth propagation through the optical system, while maintaining the refractive power of the first lens L1 to improve chromatic aberration and enhance imaging quality.

The object side surface of the first lens L1 is convex in the paraxial region, and the image side surface is convex or concave in the paraxial region. The object side surface of L1 may alternatively be configured as concave.

The curvature radius of the object side surface of the first lens L1 is defined as R1, and the curvature radius of the image side surface of the first lens L1 is defined as R2, the following relationship is satisfied: −3.03≤(R1+R2)/(R1−R2)≤−0.16. This rationally controls the shape of the first lens to effectively correct spherical aberration of the system.

The thickness on-axis of the first lens L1 is defined as d1, and the total optical length of the camera optical lenses 10, 20, 30, 40 is defined as TTL, the following relationship is satisfied: 0.065≤d1/TTL≤0.132. This facilitates ultra-thin design.

The object side surface of the second lens L2 is convex or concave in the paraxial region, and the image side surface of the second lens L2 is convex or concave in the paraxial region.

The focal length of the second lens L2 is defined as f2, and the focal length of the entire camera optical lenses 10, 20, 30, 40 is defined as f, the following relationship is satisfied: −13.36≤f2/f≤−0.55. By constraining the negative optical power of the second lens L2 within this range, it effectively corrects aberrations of the optical system.

The curvature radius of the object side surface of the second lens L2 is defined as R3, and the curvature radius of the image side surface of the second lens L2 is defined as R4, the following relationship is satisfied: −21.64≤(R3+R4)/(R3−R4)≤5.92. This constrains the shape of the second lens L2. Within this range, it facilitates correction of axial chromatic aberration while advancing toward ultra-thin and wide-angle designs.

The total optical length of the camera optical lenses 10, 20, 30, 40 is defined as TTL, and the following relationship is satisfied: 0.018≤d3/TTL≤0.066. This contributes to achieving an ultra-thin design.

The object side surface of the third lens L3 is convex in the paraxial region, and the image side surface of the third lens L3 is concave in the paraxial region. The object side surface and image side surface of the third lens L3 may alternatively be configured with other concave or convex distributions.

The focal length of the third lens L3 is defined as f3, and the focal length of the entire camera optical lenses 10, 20, 30, 40 is defined as f, the following relationship is satisfied: −4.76≤f3/f≤−0.33. By rationally allocating optical power, the system achieves superior imaging quality and reduced sensitivity.

The total optical length of the camera optical lenses 10, 20, 30, 40 is defined as TTL, and the following relationship is satisfied: 0.013≤d5/TTL≤0.082. This facilitates ultra-thin design.

By incorporating the triangular prism TP, the optical path can be folded, thereby reducing the total length of the optical system to adapt to the trend of miniaturized electronic devices.

The image height at 1.0 field of the camera optical lenses 10, 20, 30, 40 is defined as IH, the total optical length of the camera optical lenses 10, 20, 30, 40 is defined as TTL, and the following relationship is satisfied: TTL/IH≤7.22. This contributes to miniaturization.

The F-number of the camera optical lenses 10, 20, 30, 40 is less than or equal to 3.09, providing a large aperture and superior imaging performance.

In the present disclosure, an aperture stop S1 is disposed on the object side and before the first lens L1. This aperture stop S1 may alternatively be positioned elsewhere in the optical path.

In the present disclosure, between the triangular prism TP and the image plane S1, an optical filter GF may be disposed, which may be a glass cover plate or an optical filter (e.g., spectral filter). In other examples, the optical filter GF may additionally be positioned at alternative locations.

The camera optical lens 10 of the present disclosure will be described below by way of embodiments. The symbols used in each embodiment are defined as follows. The symbols used in each embodiment are as follows. The focal length, the distance on-axis, the central curvature radius, and the thickness on-axis are expressed in millimeters.

TTL: Total optical length (the distance on-axis from the object side surface of the first lens L1 to the image plane SI), expressed in millimeters.

F-number (FNO): The ratio of the effective focal length to the entrance pupil diameter of the camera optical lens.

Image height at 1.0 field (IH): Field height corresponding to the effective pixel area of the sensor (i.e., half the diagonal length of the sensor's effective pixel region).

Field of view angle at 1.0 field (FOV): Angular field of view corresponding to the effective pixel area of the sensor.

Image height at MIC field (IHm): Field height extended beyond 1.0 field to prevent assembly deviations.

Field of view angle at MIC field (FOVm): Angular field of view corresponding to IHm.

The technical solution of the present disclosure is specifically described below through four embodiments.

### Embodiment 1

The first lens L1 has positive refractive power and is made of glass, with its object side surface convex in the paraxial region and its image side surface convex in the paraxial region;

The second lens L2 has negative refractive power and is made of plastic, with its object side surface convex in the paraxial region and its image side surface concave in the paraxial region;

The third lens L3 has negative refractive power and is made of plastic, with its object side surface convex in the paraxial region and its image side surface concave in the paraxial region.

Tables 1, 2, and 3 show the design data of the camera optical lens 10 according to the first embodiment of the present disclosure.

TABLE 1

| | R | d | | nd | | vd | |
|---|---|---|---|---|---|---|---|
| S1 | ∞ | d0= | −0.460 | | | | |
| R1 | 5.316 | d1= | 1.600 | nd1 | 1.4959 | vd1 | 81.65 |
| R2 | −24.225 | d2= | 0.030 | | | | |
| R3 | 626.915 | d3= | 0.412 | nd2 | 1.6700 | vd2 | 19.39 |
| R4 | 34.369 | d4= | 0.092 | | | | |
| R5 | 3.324 | d5= | 0.853 | nd3 | 1.5444 | vd3 | 55.82 |
| R6 | 2.183 | d6= | 1.500 | | | | |
| R7 | ∞ | d7= | 6.982 | nd4 | 1.5891 | vd4 | 61.25 |
| R8 | ∞ | d8= | 6.500 | | | | |
| R9 | ∞ | d9= | 0.210 | ndg | 1.5168 | vdg | 64.17 |
| R10 | ∞ | d10= | 0.807 | | | | |

In which, the meaning of the various symbols is as follows.
S1: Aperture;
R: The curvature radius of the optical surface, the central curvature radius in case of lens;
R1: The curvature radius of the object side surface of the first lens L1;
R2: The curvature radius of the image side surface of the first lens L1;
10 R3: The curvature radius of the object side surface of the second lens L2;
R4: The curvature radius of the image side surface of the second lens L2;
R5: The curvature radius of the object side surface of the third lens L3;
R6: The curvature radius of the image side surface of the third lens L3;
R7: The curvature radius of the object side surface of the triangular prism TP;
R8: The curvature radius of the image side surface of the triangular prism TP;
R9: The curvature radius of the object side surface of the optical filter GF;
R10: The curvature radius of the image side surface of the optical filter GF;
d: The thickness on-axis of the lens and the distance on-axis between the lens;
d0: The distance on-axis from aperture S1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the triangular prism TP;
d7: The thickness on-axis of the triangular prism TP;
d8: The distance on-axis from the image side surface of the triangular prism TP to the object side surface of the optical filter GF;
d9: The thickness on-axis of the optical filter GF;
d10: The distance on-axis from the image side surface of the optical filter GF to the image plane SI;
nd: The refractive power of the d line;
nd1: The refractive power of the d line of the first lens L1;
nd2: The refractive power of the d line of the second lens L2;
nd3: The refractive power of the d line of the third lens L3;
nd4: The refractive power of the d line of the triangular prism TP;
ndg: The refractive power of the d line of the optical filter GF;
vd: The abbe number;
vd1: The abbe number of the first lens L1;
vd2: The abbe number of the second lens L2;
vd3: The abbe number of the third lens L3;
vd4: The abbe number of the triangular prism TP;
vdg: The abbe number of the optical filter GF.

Table 2 shows the aspherical data of each lens in the camera optical lens 10 according to the first embodiment of the present disclosure.

TABLE 2

| | |
|---|---|
| Conic Index | Aspherical Surface Index |

| | k | A4 | A6 | A8 | A10 | A12 |
|---|---|---|---|---|---|---|
| R1 | −9.5839E−01 | 3.0795E−03 | −5.0356E−04 | 8.2246E−04 | −8.7499E−04 | 5.7935E−04 |
| R2 | 5.5038E+00 | 2.5011E−02 | −7.0471E−03 | −1.4091E−02 | 2.3707E−02 | −1.7833E−02 |
| R3 | −1.7612E+01 | 1.5880E−03 | 8.8151E−03 | −2.5958E−02 | 3.1888E−02 | −2.1849E−02 |
| R4 | 2.3770E+01 | 5.1040E−03 | 6.1473E−03 | −2.3819E−02 | 2.9936E−02 | −2.0411E−02 |
| R5 | −2.9244E+00 | 3.8830E−02 | −1.5737E−02 | −2.1500E−03 | 7.7579E−03 | −3.5393E−03 |
| R6 | −1.2949E+00 | 1.8388E−02 | −1.6621E−02 | 4.2034E−02 | −8.2288E−02 | 1.0469E−01 |

| | Conic Index | Aspherical Surface Index | | | | |
|---|---|---|---|---|---|---|
| | k | A14 | A16 | A18 | A20 | A22 |
| R1 | −9.5839E−01 | −2.6080E−04 | 8.2927E−05 | −1.8914E−05 | 3.1033E−06 | −3.6308E−07 |
| R2 | 5.5038E+00 | 8.1728E−03 | −2.5055E−03 | 5.3547E−04 | −8.1113E−05 | 8.6956E−06 |
| R3 | −1.7612E+01 | 9.5621E−03 | −2.8616E−03 | 6.0579E−04 | −9.1903E−05 | 9.9544E−06 |
| R4 | 2.3770E+01 | 8.8665E−03 | −2.6505E−03 | 5.6649E−04 | −8.7867E−05 | 9.8584E−06 |
| R5 | −2.9244E+00 | −2.9378E−04 | 9.1821E−04 | −4.3887E−04 | 1.1730E−04 | −2.0213E−05 |
| R6 | −1.2949E+00 | −8.8968E−02 | 5.2321E−02 | −2.1841E−02 | 6.5450E−03 | −1.4023E−03 |

| | |
|---|---|
| Conic Index | Aspherical Surface Index |

| | k | A24 | A26 | A28 | A30 |
|---|---|---|---|---|---|
| R1 | −9.5839E−01 | 2.9552E−08 | −1.5899E−09 | 5.0813E−11 | −7.3025E−13 |
| R2 | 5.5038E+00 | −6.4626E−07 | 3.1716E−08 | −9.2548E−10 | 1.2170E−11 |
| R3 | −1.7612E+01 | −7.5299E−07 | 3.7853E−08 | −1.1379E−09 | 1.5500E−11 |
| R4 | 2.3770E+01 | −7.8236E−07 | 4.1768E−08 | −1.3493E−09 | 1.9981E−11 |
| R5 | −2.9244E+00 | 2.3058E−06 | −1.6922E−07 | 7.2558E−09 | −1.3813E−10 |
| R6 | −1.2949E+00 | 2.0999E−04 | −2.0895E−05 | 1.2413E−06 | −3.3302E−08 |

For the sake of convenience, the aspherical surfaces of each lens surface are expressed using the aspherical polynomial form shown in Equation (1) below. However, the present disclosure is not limited to the aspherical polynomial form represented by Equation (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Among them, K is a conic index, A4, A6, A8, A10, A12, A14, A16, A18, A20, A22, A24, A26, A28, A30 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

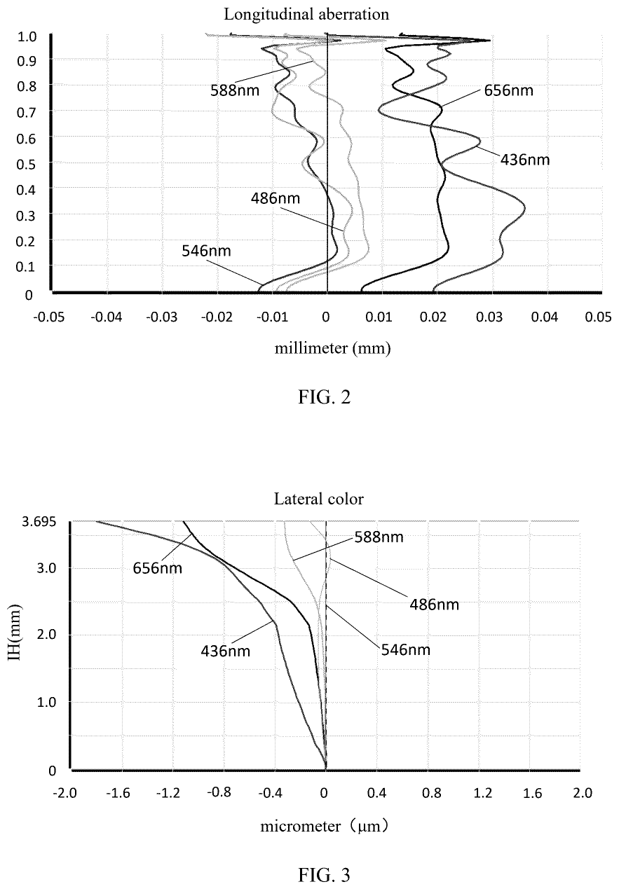

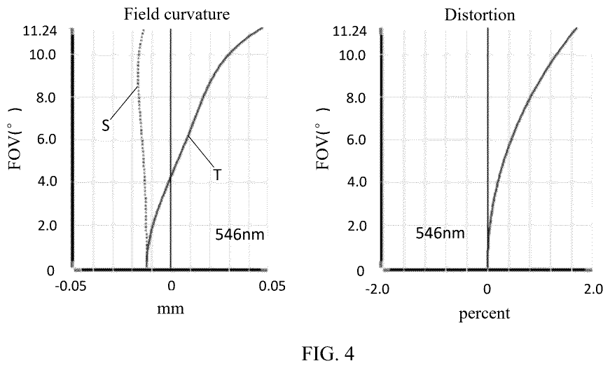

FIG. 2 and FIG. 3 show the longitudinal aberration and lateral color schematic diagrams after light with a wavelength of 656 nm, 588 nm, 546 nm, 486 nm and 436 nm passes the camera optical lens 10 of the first embodiment. FIG. 4 show the field curvature and distortion schematic diagrams after light with a wavelength of 546 nm passes the camera optical lens 10 of the first embodiment. In FIG. 4, the field curvature S denotes the sagittal field curvature, and T denotes the tangential field curvature.

In this embodiment, the entrance pupil diameter (ENPD) of the camera optical lens 10 is 6.363 mm, the image height at 1.0 field (IH) is 3.575 mm, the field of view angle at 1.0 field (FOV) is 21.79°, the image height at MIC field (IHm) is 3.695 mm, and the field of view angle at MIC field (FOVm) is 22.48°. The camera optical lens 10 satisfies the design requirements of large aperture, telephoto capability, and miniaturization. Its on-axis and off-axis chromatic aberrations are fully corrected, exhibiting excellent optical characteristics.

### Embodiment 2

The meaning of the symbols in the second embodiment is the same as that in the first embodiment.

The second embodiment differs from the first embodiment in that: the image side surface of the first lens L1 is concave in the paraxial region.

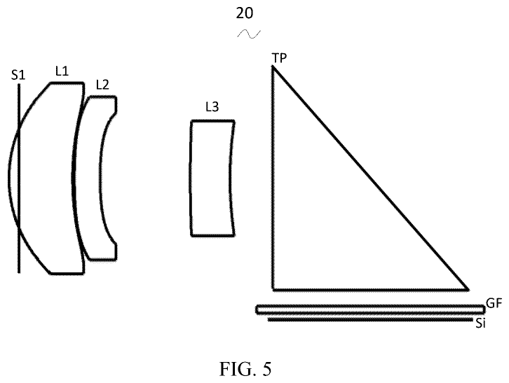

FIG. 5 shows the camera optical lens 20 according to the second embodiment of the present disclosure.

Tables 3 and 4 show the design data of the camera optical lens 20 according to the second embodiment of the present disclosure.

TABLE 3

| | R | d | | nd | | vd | |
|---|---|---|---|---|---|---|---|
| S1 | ∞ | d0= | −0.356 | | | | |
| R1 | 3.473 | d1= | 2.231 | nd1 | 1.4959 | vd1 | 81.65 |
| R2 | 6.911 | d2= | 0.064 | | | | |
| R3 | 11.620 | d3= | 0.902 | nd2 | 1.6700 | vd2 | 19.39 |
| R4 | 8.260 | d4= | 3.163 | | | | |
| R5 | 28.447 | d5= | 1.396 | nd3 | 1.5444 | vd3 | 55.82 |
| R6 | 9.482 | d6= | 1.500 | | | | |
| R7 | ∞ | d7= | 6.854 | nd4 | 1.5661 | vd4 | 37.71 |
| R8 | ∞ | d8= | 0.500 | | | | |
| R9 | ∞ | d9= | 0.210 | ndg | 1.5168 | vdg | 64.17 |
| R10 | ∞ | d10= | 0.210 | | | | |

Table 4 shows the aspherical data of each lens in the camera optical lens 20 according to the second embodiment of the present disclosure.

TABLE 4

| | Conic Index | Aspherical Surface Index | | | | |
|---|---|---|---|---|---|---|
| | k | A4 | A6 | A8 | A10 | A12 |
| R1 | −9.4028E−01 | 2.0720E−03 | 4.8624E−04 | −2.4642E−04 | 9.8526E−05 | −2.5750E−05 |
| R2 | −2.1660E+01 | −1.9798E−02 | 3.6773E−02 | −2.7003E−02 | 1.1598E−02 | −3.1245E−03 |
| R3 | 1.7644E+01 | −1.8147E−02 | 3.1100E−02 | −2.2767E−02 | 1.0056E−02 | −2.7971E−03 |
| R4 | 1.3015E+01 | 5.3559E−03 | 3.2584E−03 | −1.0516E−03 | −1.0484E−03 | 1.5095E−03 |
| R5 | 9.9000E+01 | −4.1488E−03 | 7.9162E−03 | −1.9775E−02 | 2.9192E−02 | −2.6188E−02 |
| R6 | 1.0653E+01 | −3.5216E−03 | 2.9614E−05 | 1.6961E−04 | −4.7945E−04 | 5.7920E−04 |

| | Conic Index | Aspherical Surface Index | | | |
|---|---|---|---|---|---|
| | k | A14 | A16 | A18 | A20 |
| R1 | −9.4028E−01 | 4.2785E−06 | −4.3462E−07 | 2.4452E−08 | −5.8746E−10 |
| R2 | −2.1660E+01 | 5.3351E−04 | −5.6190E−05 | 3.3364E−06 | −8.5562E−08 |
| R3 | 1.7644E+01 | 4.9467E−04 | −5.4128E−05 | 3.3512E−06 | −9.0155E−08 |
| R4 | 1.3015E+01 | −7.8044E−04 | 2.0909E−04 | −2.8815E−05 | 1.6208E−06 |
| R5 | 9.9000E+01 | 1.4520E−02 | −4.8572E−03 | 8.9856E−04 | −7.0599E−05 |
| R6 | 1.0653E+01 | −3.9023E−04 | 1.5029E−04 | −3.0672E−05 | 2.5661E−06 |

For the sake of convenience, the aspherical surfaces of each lens surface are expressed using the aspherical polynomial form shown in Equation (2) below. However, the present disclosure is not limited to the aspherical polynomial form represented by Equation (2).

$$z = ( c {r}^{2} ) / \{ 1 + {[ 1 - ( k + 1 ) ( {c}^{2} {r}^{2} ) ]}^{1 / 2} \} + A 4 {r}^{4} + 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Among them, K is a conic index, A4, A6, A8, A10, A12, A14, A16, A18, A20 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

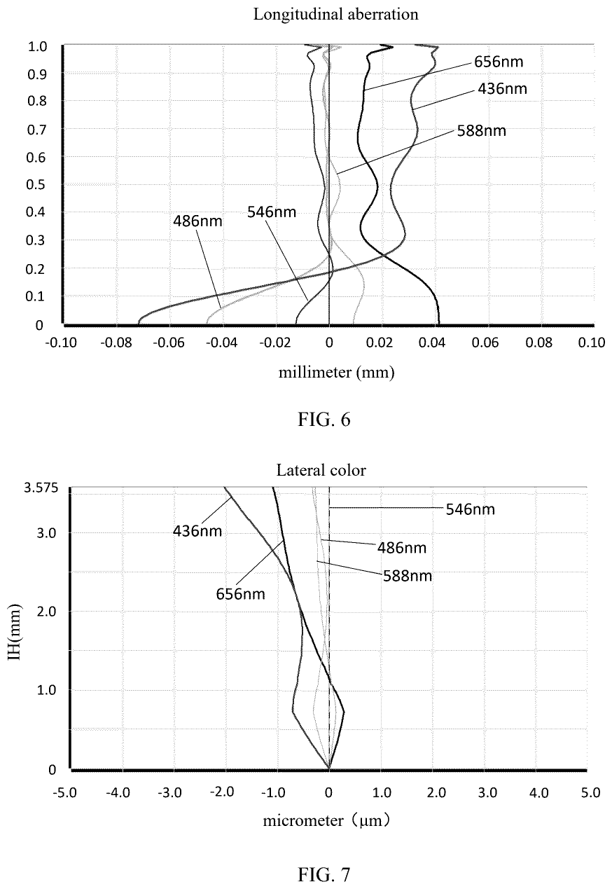

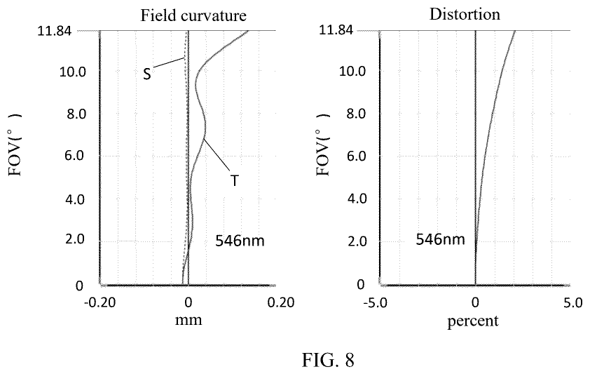

FIG. 6 and FIG. 7 show the longitudinal aberration and lateral color schematic diagrams after light with a wavelength of 656 nm, 588 nm, 546 nm, 486 nm and 436 nm passes the camera optical lens 20 of the second embodiment. FIG. 8 show the field curvature and distortion schematic diagrams after light with a wavelength of 546 nm passes the camera optical lens 20 of the second embodiment. In FIG. 8, the field curvature S denotes the sagittal field curvature, and T denotes the tangential field curvature.

In this embodiment, the entrance pupil diameter (ENPD) of the camera optical lens 20 is 5.815 mm, the image height at 1.0 field (IH) is 3.575 mm, the field of view angle at 1.0 field (FOV) is 23.68°, the image height at MIC field (IHm) is 3.695 mm, and the field of view angle at MIC field (FOVm) is 24.42°. The camera optical lens 20 satisfies the design requirements of large aperture, telephoto capability, and miniaturization. Its on-axis and off-axis chromatic aberrations are fully corrected, exhibiting excellent optical characteristics.

### Embodiment 3

The meaning of the symbols in the third embodiment is the same as that in the first embodiment.

The third embodiment differs from the first embodiment in that: the object side surface of the second lens L2 is concave in the paraxial region, the image side surface of the second lens L2 is convex in the paraxial region.

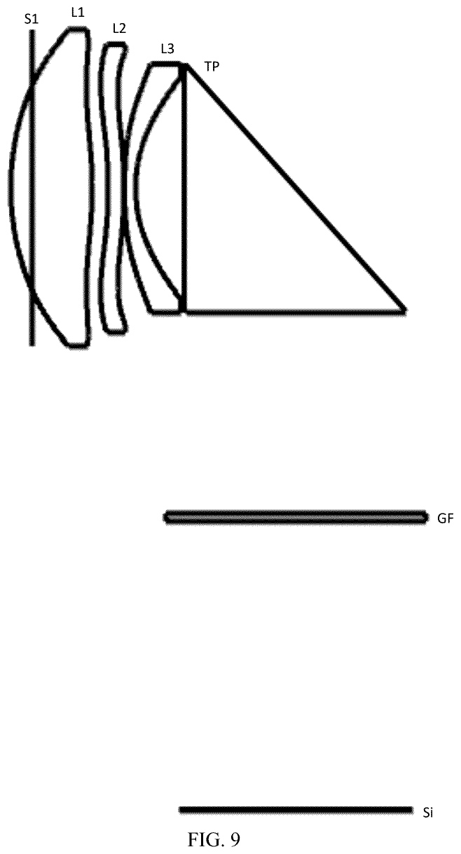

FIG. 9 shows the camera optical lens 30 according to the third embodiment of the present disclosure.

Tables 5 and 6 show the design data of the camera optical lens 30 according to the third embodiment of the present disclosure.

TABLE 5

| | R | d | | nd | | vd | |
|---|---|---|---|---|---|---|---|
| S1 | ∞ | d0= | −0.656 | | | | |
| R1 | 6.395 | d1= | 2.500 | nd1 | 1.4959 | vd1 | 81.65 |
| R2 | −8.948 | d2= | 0.481 | | | | |
| R3 | −18.578 | d3= | 0.484 | nd2 | 1.6700 | vd2 | 19.39 |
| R4 | −20.379 | d4= | 0.030 | | | | |
| R5 | 23.959 | d5= | 0.340 | nd3 | 1.5444 | vd3 | 55.82 |
| R6 | 4.006 | d6= | 1.500 | | | | |
| R7 | ∞ | d7= | 6.831 | nd4 | 1.5444 | vd4 | 55.82 |
| R8 | ∞ | d8= | 5.500 | | | | |
| R9 | ∞ | d9= | 0.210 | ndg | 1.5168 | vdg | 64.17 |
| R10 | ∞ | d10= | 7.931 | | | | |

Table 6 shows the aspherical data of each lens in the camera optical lens 30 according to the third embodiment of the present disclosure.

TABLE 6

| | Conic Index | Aspherical Surface Index | | | | |
|---|---|---|---|---|---|---|
| | k | A4 | A6 | A8 | A10 | A12 |
| R1 | −1.6393E+00 | 6.8803E−04 | 3.6372E−05 | 4.0799E−06 | −2.4495E−06 | 5.5761E−07 |
| R2 | −1.6717E+01 | 3.1805E−03 | −2.8762E−04 | 1.0168E−04 | −1.8343E−05 | 1.5793E−06 |
| R3 | 1.9031E+01 | −1.3895E−02 | 3.8881E−03 | −9.4225E−05 | −1.1461E−04 | 2.4555E−05 |
| R4 | −1.1996E+01 | −1.2430E−02 | 2.3876E−03 | 6.0386E−04 | −2.9712E−04 | 5.2595E−05 |
| R5 | 1.8171E+01 | 3.6952E−02 | −1.9023E−02 | 6.4043E−03 | −1.3738E−03 | 1.8983E−04 |
| R6 | −9.8707E−01 | 3.2135E−02 | −1.6732E−02 | 4.7181E−03 | −7.0214E−04 | 3.1633E−05 |

| | Conic Index | Aspherical Surface Index | | | |
|---|---|---|---|---|---|
| | k | A14 | A16 | A18 | A20 |
| R1 | −1.6393E+00 | −6.4828E−08 | 4.0544E−09 | −1.2981E−10 | 1.6571E−12 |
| R2 | −1.6717E+01 | −6.2199E−08 | 3.7609E−10 | 4.3617E−11 | −9.2395E−13 |
| R3 | 1.9031E+01 | −2.4779E−06 | 1.3877E−07 | −4.1512E−09 | 5.1919E−11 |
| R4 | −1.1996E+01 | −5.0457E−06 | 2.7467E−07 | −7.8979E−09 | 9.1756E−11 |
| R5 | 1.8171E+01 | −1.6806E−05 | 9.1441E−07 | −2.7539E−08 | 3.4560E−10 |
| R6 | −9.8707E−01 | 6.3003E−06 | −1.1469E−06 | 7.5469E−08 | −1.8641E−09 |

For the sake of convenience, the aspherical surfaces of each lens surface are expressed using the aspherical polynomial form shown in Equation (2) below. However, the present disclosure is not limited to the aspherical polynomial form represented by Equation (2).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Among them, K is a conic index, A4, A6, A8, A10, A12, A14, A16, A18, A20 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

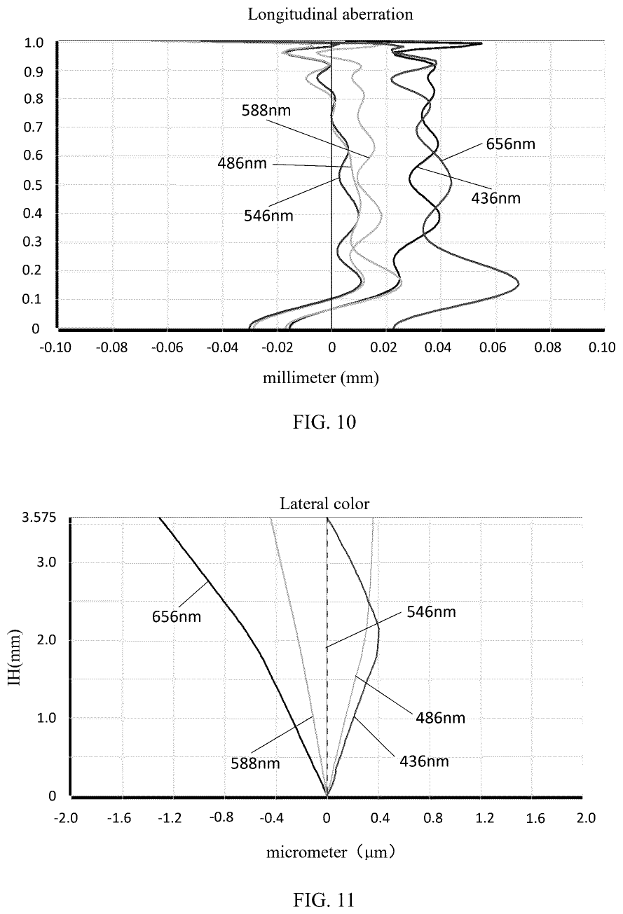

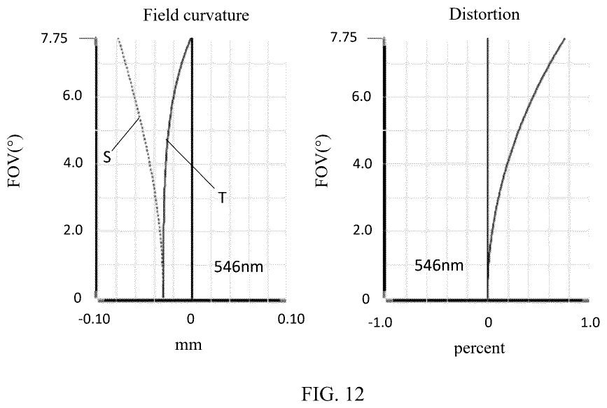

FIG. 10 and FIG. 11 show the longitudinal aberration and lateral color schematic diagrams after light with a wavelength of 656 nm, 588 nm, 546 nm, 486 nm and 436 nm passes the camera optical lens 30 of the third embodiment. FIG. 12 show the field curvature and distortion schematic diagrams after light with a wavelength of 546 nm passes the camera optical lens 30 of the third embodiment. In FIG. 12, the field curvature S denotes the sagittal field curvature, and T denotes the tangential field curvature.

In this embodiment, the entrance pupil diameter (ENPD) of the camera optical lens 30 is 8.680 mm, the image height at 1.0 field (IH) is 3.575 mm, the field of view angle at 1.0 field (FOV) is 15.49°, the image height at MIC field (IHm) is 3.695 mm, and the field of view angle at MIC field (FOVm) is 16.00°. The camera optical lens 30 satisfies the design requirements of large aperture, telephoto capability, and miniaturization. Its on-axis and off-axis chromatic aberrations are fully corrected, exhibiting excellent optical characteristics.

### Embodiment 4

The meaning of the symbols in the fourth embodiment is the same as that in the first embodiment.

The fourth embodiment differs from the first embodiment in that: the object side surface of the second lens L2 is concave in the paraxial region, the image side surface of the second lens L2 is convex in the paraxial region.

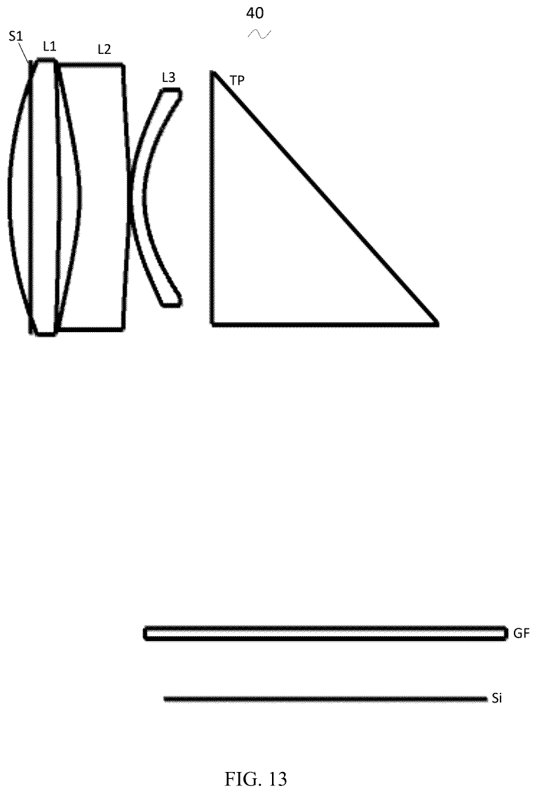

FIG. 13 shows the camera optical lens 40 according to the fourth embodiment of the present disclosure.

Tables 7 and 8 show the design data of the camera optical lens 40 according to the fourth embodiment of the present disclosure.

TABLE 7

| | R | d | | nd | | vd | |
|---|---|---|---|---|---|---|---|
| S1 | ∞ | d0= | −0.460 | | | | |
| R1 | 6.193 | d1= | 1.100 | nd1 | 1.8438 | vd1 | 40.26 |
| R2 | −19.856 | d2= | 0.449 | | | | |
| R3 | −3.440 | d3= | 1.103 | nd2 | 1.6461 | vd2 | 22.26 |
| R4 | −9.939 | d4= | 0.030 | | | | |
| R5 | 2.314 | d5= | 0.300 | nd3 | 1.6114 | vd3 | 25.09 |
| R6 | 2.093 | d6= | 1.500 | | | | |
| R7 | ∞ | d7= | 5.015 | nd4 | 1.5661 | vd4 | 37.71 |
| R8 | ∞ | d8= | 6.000 | | | | |
| R9 | ∞ | d9= | 0.210 | ndg | 1.5168 | vdg | 64.17 |
| R10 | ∞ | d10= | 1.185 | | | | |

Table 8 shows the aspherical data of each lens in the camera optical lens 40 according to the fourth embodiment of the present disclosure.

TABLE 8

| | Conic Index | Aspherical Surface Index | | | | |
|---|---|---|---|---|---|---|
| | k | A4 | A6 | A8 | A10 | A12 |
| R1 | −2.5248E+00 | 1.8658E−03 | 9.4429E−05 | −1.1252E−04 | 2.8346E−05 | −3.0221E−06 |
| R2 | 3.9667E+01 | 8.2389E−03 | −1.7319E−03 | 1.0872E−04 | 7.1890E−05 | −2.4060E−05 |
| R3 | −1.4038E+01 | 2.4167E−03 | −1.8951E−03 | 1.1505E−03 | −4.2679E−04 | 1.0038E−04 |
| R4 | −3.5732E+01 | −3.6927E−03 | 9.2671E−03 | −4.7471E−03 | 1.2026E−03 | −1.4675E−04 |
| R5 | −5.7101E+00 | −1.5368E−03 | 4.5729E−04 | 1.1502E−02 | −1.0493E−02 | 4.3886E−03 |
| R6 | −2.0128E+00 | −1.2988E−02 | −2.9179E−04 | 1.5825E−02 | −1.3543E−02 | 5.5563E−03 |

| | |
|---|---|
| Conic Index | Aspherical Surface Index |

| | k | A14 | A16 | A18 | A20 |
|---|---|---|---|---|---|
| R1 | −2.5248E+00 | 1.3388E−08 | 2.0850E−08 | −1.1731E−09 | −7.1263E−12 |
| R2 | 3.9667E+01 | 3.3296E−06 | −2.0652E−07 | 2.0982E−09 | 2.2346E−10 |
| R3 | −1.4038E+01 | −1.5230E−05 | 1.4572E−06 | −8.0749E−08 | 1.9910E−09 |
| R4 | −3.5732E+01 | 1.3273E−06 | 1.8995E−06 | −2.1642E−07 | 7.9321E−09 |
| R5 | −5.7101E+00 | −1.0423E−03 | 1.4464E−04 | −1.0928E−05 | 3.4685E−07 |
| R6 | −2.0128E+00 | −1.2792E−03 | 1.6281E−04 | −9.8335E−06 | 1.5728E−07 |

For the sake of convenience, the aspherical surfaces of each lens surface are expressed using the aspherical polynomial form shown in Equation (2) below. However, the present disclosure is not limited to the aspherical polynomial form represented by Equation (2).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Among them, K is a conic index, A4, A6, A8, A10, A12, A14, A16, A18, A20 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

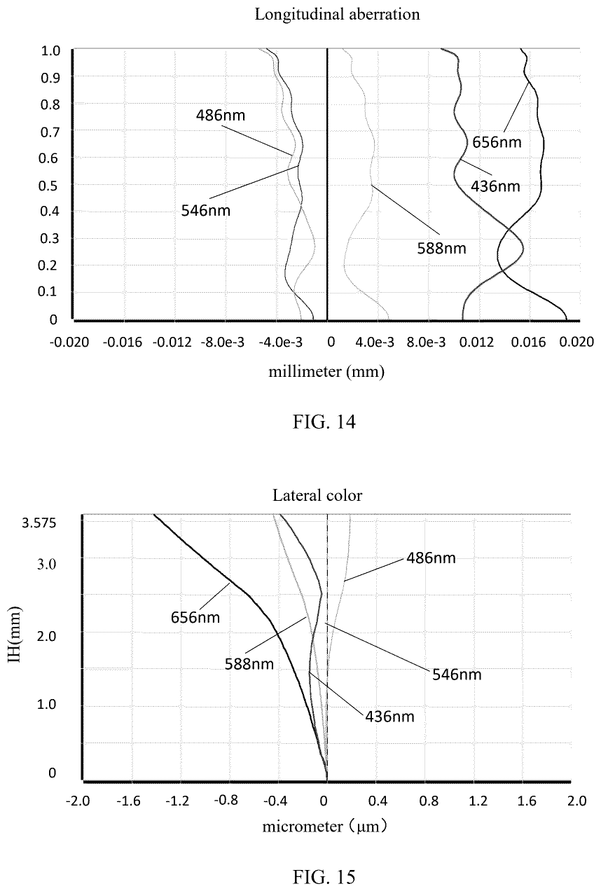

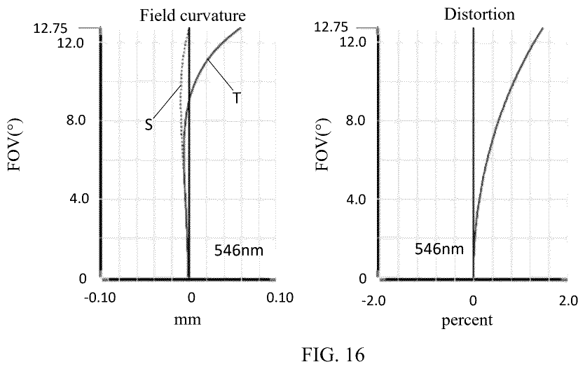

FIG. 14 and FIG. 15 show the longitudinal aberration and lateral color schematic diagrams after light with a wavelength of 656 nm, 588 nm, 546 nm, 486 nm and 436 nm passes the camera optical lens 40 of the fourth embodiment. FIG. 16 show the field curvature and distortion schematic diagrams after light with a wavelength of 546 nm passes the camera optical lens 40 of the fourth embodiment. In FIG. 16, the field curvature S denotes the sagittal field curvature, and T denotes the tangential field curvature.

In this embodiment, the entrance pupil diameter (ENPD) of the camera optical lens 40 is 5.425 mm, the image height at 1.0 field (IH) is 3.575 mm, the field of view angle at 1.0 field (FOV) is 25.50°, the image height at MIC field (IHm) is 3.695 mm, and the field of view angle at MIC field (FOVm) is 26.31°. The camera optical lens 40 satisfies the design requirements of large aperture, telephoto capability, and miniaturization. Its on-axis and off-axis chromatic aberrations are fully corrected, exhibiting excellent optical characteristics.

Subsequent Table 9 lists the values corresponding to specified parameters in the conditional expressions for each of Embodiments 1, 2, 3, and 4.

TABLE 9

| Parameters and | | | | |
|---|---|---|---|---|
| Conditional | Embodiment | Embodiment | Embodiment | Embodiment |
| Expressions | 1 | 2 | 3 | 4 |
| D/TTL | 0.157 | 0.455 | 0.149 | 0.177 |
| vdi | 81.650 | 81.650 | 81.650 | 40.260 |
| f1/f | 0.488 | 0.692 | 0.304 | 0.364 |
| f23/(d3 + | −8.716 | −3.000 | −32.080 | −5.081 |
| d4 + d5) | | | | |
| (R5 + R6)/ | 4.826 | 2.000 | 1.402 | 19.941 |
| (R5 − R6) | | | | |
| f | 18.269 | 16.694 | 26.040 | 15.575 |
| f1 | 8.924 | 11.547 | 7.927 | 5.671 |
| f2 | −53.638 | −47.251 | −347.652 | −8.638 |
| f3 | −15.812 | −26.711 | −8.852 | −74.133 |
| f12 | 10.430 | 13.534 | 8.156 | 13.999 |
| Fno | 2.871 | 2.871 | 3.000 | 2.871 |
| TTL | 18.986 | 17.030 | 25.807 | 16.892 |
| IH | 3.575 | 3.575 | 3.575 | 3.575 |
| FOV | 21.79° | 23.68° | 15.49° | 8.13° |

A person of ordinary skill in the art will appreciate that the embodiments described above are specific implementations for realizing the present disclosure. In practical applications, various modifications may be made in form and detail without departing from the spirit and scope of the present disclosure.

What is claimed is:

1. A camera optical lens comprising, in an order from an object side to an image side in sequence: a first lens with positive refractive power, a second lens with negative refractive power, a third lens with negative refractive power, and a triangular prism with negative refractive power; wherein at least one of the first lens, the second lens, and the third lens is a glass lens element, the triangular prism is made of plastic material, and the camera optical lens further satisfies the following conditions:
$$14 \leq D / T T L \leq 0.46 ;$$
$$40. \leq vdi \leq 82 \text{.00} ;$$
$$0.3 \leq fl / f \leq 0 \text{.70} ;$$
$$- 32. 08 \leq f 23 / ( d 3 + d 4 + d 5 ) \leq - 3 \text{.00} ;$$
$$1.4 \leq ( R 5 + R 6 ) / ( R 5 - R 6 ) \leq 20 \text{.00} ;$$
where
D: the distance on-axis from the object side surface of the first lens to the image side surface of the third lens;
TTL: the total optical length of the camera optical lens;
vdi: the abbe number of the glass lens element in the camera optical lens;
f: the focal length of the camera optical lens;
f1: the focal length of the first lens;
d3: the thickness on-axis of the second lens;
d5: the thickness on-axis of the third lens;
d4: the thickness on-axis from the image side surface of the second lens to the object side surface of the third lens;
f23: the combined focal length of the second lens and the third lens;
R5: the curvature radius of the object side surface of the third lens;
R6: the curvature radius of the image side surface of the third lens.

2. The camera optical lens as described in claim 1, further satisfying the following condition:
$$2.1 \leq I H \times f / F O V \leq 6 \text{.10} ;$$
IH: the image height at 1.0 field of the camera optical lens;
FOV: the field angle at 1.0 field of the camera optical lens.

3. The camera optical lens as described in claim 1, further satisfying the following condition:
$$3.1 \leq f l / d l \leq 5 \text{.60} ;$$
where
d1: the thickness on-axis of the first lens.

4. The camera optical lens as described in claim 1, wherein an object side surface of the first lens is convex in the paraxial region, and the camera optical lens further satisfies the following conditions:
$$- 3.03 \leq ( R 1 + R 2 ) / ( R 1 - R 2 ) \leq - 0.16 ;$$
$$0.065 \leq dl / TTL \leq 0.1 \; 32 ;$$
where
R1: the curvature radius of the object side surface of the first lens;
R2: the curvature radius of the image side surface of the first lens;
d1: the thickness on-axis of the first lens.

5. The camera optical lens as described in claim 1, further satisfying the following conditions:
$$- 13.36 \leq f 2 / f \leq - 0.55 ;$$
$$- 21. 64 \leq ( R 3 + R 4 ) / ( R 3 - R 4 ) \leq 5 \text{.92} ;$$
$$0.018 \leq d 3 / TTL \leq 0.0 \; 66 ;$$
where
f2: the focal length of the second lens;
R3: the curvature radius of the object side surface of the second lens;
R4: the curvature radius of the image side surface of the second lens.

6. The camera optical lens as described in claim 1, wherein an object side surface of the third lens is convex in the paraxial region, an image side surface of the third lens is concave in the paraxial region, and the camera optical lens further satisfies the following conditions:
$$- 4.76 \leq f 3 / f \leq - 0.33 ;$$
$$0.013 \leq d 5 / TTL \leq 0.0 \; 82 ;$$
where
f3: the focal length of the third lens.

7. The camera optical lens as described in claim 1, further satisfying the following condition:
$$Fno \leq 3.09 ;$$
where
Fno: the F-number of the camera optical lens.

8. The camera optical lens as described in claim 1, further satisfying the following condition:
$$TTL / IH \leq 7 \text{.22} ;$$
where
IH: the image height at 1.0 field of the camera optical lens.
